(19) United States
(12) Patent Application Publication
(10) Pub. No.: US 2017/0074009 A1
(43) Pub. Date: Mar. 16, 2017

(54) TOUCHLESS VEHICLE CONTROL APPARATUS AND SYSTEMS INCORPORATING THE SAME

(71) Applicant: ADAC PLASTICS, INC., GRAND RAPIDS, MI (US)

(72) Inventors: Charles Bruce Banter, Northville, MI (US); Robert Bingle, Walker, MI (US)

(21) Appl. No.: 15/262,647

(22) Filed: Sep. 12, 2016

Related U.S. Application Data
(60) Provisional application No. 62/217,842, filed on Sep. 12, 2015.

(51) Int. Cl. E05B 81/78; E05B 85/10

(52) U.S. Cl. CPC E05B 81/78; E05B 81/77; E05B 85/10; G08C 23/04

(57) ABSTRACT

A touchless vehicle control apparatus includes an array of infrared light-emitting LEDs; an array of infrared light sensors for receiving reflected light from an object in accordance with a time sequence in which one or more of the infrared light-emitting LEDs is activated and outputting a plurality of reflected signals; and a processing unit for receiving the reflected signals, identifying a signal function of time by comparing a predetermined threshold with signal levels of the reflected signals, determining motion of the object by referring to the signal function of time, and directing the execution of one or more pre-defined vehicle commands when the determined motion of the object corresponds to a pre-defined motion associated with a vehicle command.

### CROSS-REFERENCE TO RELATED APPLICATIONS

The present application is related to, and claims the benefit of priority from, U.S. Provisional Application Ser. No. 62/217,842, filed 12 Sep. 2015, the disclosure of which is incorporated herein by reference in its entirety.

### FIELD OF THE INVENTION

The present invention relates to user-actuatable, touchless control apparatus for vehicles (e.g., automobiles), such as may be incorporated into a vehicle handle or trim component to facilitate locking, unlocking, and/or actuating a closure (e.g., a door, lift gate, trunk, etc.) and/or operating a vehicle system (e.g., windows, lighting, etc.).

### BACKGROUND OF THE INVENTION

Touchless actuation systems are becoming commonplace in environments where human contact with a device is unwanted or undesirable. For instance, it is usual to find touchless soap dispensers, faucets, and hand dryers in public washrooms. Such touchless actuation systems are, at best, capable of binary operation only. That is, they detect the presence of an object (e.g., a human hand or hands) only and, on the basis of such detection, activate or deactivate a device. In this manner, a user's placing his hands under a faucet will result in actuation of a valve to release water from the faucet (typically for a predetermined length of time). In some embodiments, the detected presence of the user's hand or hands will serve to actuate a valve to release water from the faucet until the user's hand or hands are again detected by the system's sensor or sensors.

Infrared (“IR”) sensors may be employed in touchless actuation systems of the simple, binary-operation type described above. Typically, such systems use an active near infrared arrangement in which multiple IR LEDs and one or more sensors are employed, with the one or more sensors calculating the distance of an object from each LED by timing the interval between emission and reception of the IR signals and, via a computer processor, interpreting the received information to determine movement within the IR field.

Exemplary IR movement recognition systems are disclosed in US Patent Application Publication 20120200486, US Patent Application Publication 20150069249, and US Patent Application Publication 20120312956, the disclosures of which are incorporated herein by reference in their entireties.

### SUMMARY OF THE DISCLOSURE

Disclosed herein is a touchless vehicle control apparatus, comprising: An array of infrared light-emitting LEDs; an array of infrared light sensors for receiving reflected infrared light from an object in accordance with a time sequence in which one or more of the infrared light-emitting LEDs is activated, and outputting a plurality of reflected signals; and a processing unit for receiving the reflected signals, identifying a signal function of time by comparing a predetermined threshold with signal levels of the reflected signals, determining motion of the object by referring to the signal function of time, and directing the execution of one or more pre-defined vehicle commands when the determined motion of the object corresponds to a pre-defined motion associated with a vehicle command.

In one embodiment, the apparatus is embodied in a vehicle door release-handle.

In another embodiment, the apparatus is adapted to be secured to a vehicle adjacent to a door of the vehicle. More particularly, the apparatus is in one form adapted to be mounted in a vertically-oriented seam between adjacent doors in a vehicle, with the array of infrared light-emitting LEDs and the array of infrared light so as to be able to emit and detect IR light along a length of the seam. According to this form of the invention, the apparatus further comprises a support member adapted to be secured to the vehicle body in the seam between adjacent doors.

In a further embodiment, the apparatus is adapted to be secured to a vehicle at a location remote from a door of the vehicle.

The present disclosure further comprehends an access system for a vehicle of the type comprising one or more doors providing access to the vehicle interior, comprising:

a recess or pocket provided along the inside edge of each of the one or more doors, the recess or pocket dimensioned to receive the fingers of a user in order to facilitate opening the door;

a mechanism for at least partially opening each of the one or more doors to a position at which a user can access the recess or pocket in the door; and

a touchless control apparatus including an array of infrared light-emitting LEDs, an array of infrared light sensors for receiving reflected light from an object in accordance with a time sequence in which one or more of the infrared light-emitting LEDs is activated and outputting a plurality of reflected signals, and a processing unit for receiving the reflected signals, identifying a signal function of time by comparing a predetermined threshold with signal levels of the reflected signals, determining motion of the object by referring to the signal function of time, and directing the execution of one or more pre-defined vehicle commands when the determined motion of the object corresponds to a pre-defined motion associated with a vehicle command. The one or more pre-defined vehicle commands includes actuation of the mechanism for at least partially each of the one or more doors so as to partially open at least one of the doors in response to a pre-defined motion of the object.

According to one aspect of the invention, the touchless control apparatus is adapted to be secured to the vehicle adjacent to at least one of the one or more doors.

Per another feature, the touchless control apparatus is adapted to be mounted in a vertically-oriented seam adjacent at least one or the one or more doors, with the array of infrared light-emitting LEDs and the array of infrared light so as to be able to emit and detect IR light along a length of the seam.

According to yet another feature, the touchless control apparatus further comprises a support member adapted to be secured to the vehicle body in the seam adjacent the at least one or more doors.

In one form, the vehicle includes at least a pair of doors which are positioned adjacent to each other. Further, the touchless control apparatus is adapted to be mounted in a vertically-oriented seam between the adjacent doors, with the array of infrared light-emitting LEDs and the array of infrared light so as to be able to emit and detect IR light along a length of the seam.

Per one aspect of the invention, the touchless control apparatus further comprises a support member adapted to be secured to the vehicle body in the seam between adjacent doors.

### BRIEF DESCRIPTION OF THE DRAWINGS

The foregoing and other features and advantages of the present invention may be better understood with reference to the specification and accompanying drawings, of which:

FIG. 1 depicts in perspective view a first embodiment of the present invention, wherein the touchless vehicle control apparatus is embodied in a vehicle door release handle;

FIG. 2 is an exploded perspective view of the release handle of FIG. 1;

FIG. 3 is a perspective view of the release handle of FIG. 1, shown in a partially assembled state;

FIG. 4 is a rear view of the release handle of FIG. 3;

FIG. 5 is a detailed view of the release handle of FIG. 1, shown in partial cross-section taken along the length of the handle;

FIG. 6 shows a second embodiment of the present invention, wherein the touchless vehicle control apparatus is adapted to be secured to a vehicle adjacent to at least one door of the vehicle;

FIG. 7 shows the embodiment of FIG. 6, with one of the vehicle doors removed to provide greater visibility of the touchless vehicle control apparatus;

FIG. 8 is a detailed view of the touchless vehicle control apparatus of FIG. 7, shown in partial cross-section taken along the length of the handle;

FIG. 9 is a detailed view of one of the vehicle doors of FIG. 6, depicting the recess or pocket provided along the inside edge of the door;

FIG. 10 is a rear view of the vehicle door of FIG. 9; and

FIG. 11 is a detailed, partial view of the vehicle door of FIGS. 9 and 10.

### DETAILED DESCRIPTION

Referring now to the drawings, wherein like numbers indicate like or corresponding parts throughout the several views, there is disclosed in multiple embodiments a touchless vehicle control apparatus comprising: An array of infrared light-emitting LEDs; an array of infrared light sensors for receiving reflected infrared light from an object in accordance with a time sequence in which one or more of the infrared light-emitting LEDs is activated, and outputting a plurality of reflected signals; and a processing unit for receiving the reflected signals, identifying a signal function of time by comparing a predetermined threshold with signal levels of the reflected signals, determining motion of the object by referring to the signal function of time, and directing the execution of one or more pre-defined vehicle commands when the determined motion of the object corresponds to a pre-defined motion associated with a vehicle command. The present invention so constituted permits a user's touchless actuation (e.g., through hand gestures) of various vehicle systems, such as, by way of non-limiting example, door locks, the opening and closing of closures (e.g., a door, lift gate, trunk, etc.), opening and closing windows, turning on/off internal and/or external lighting, etc.

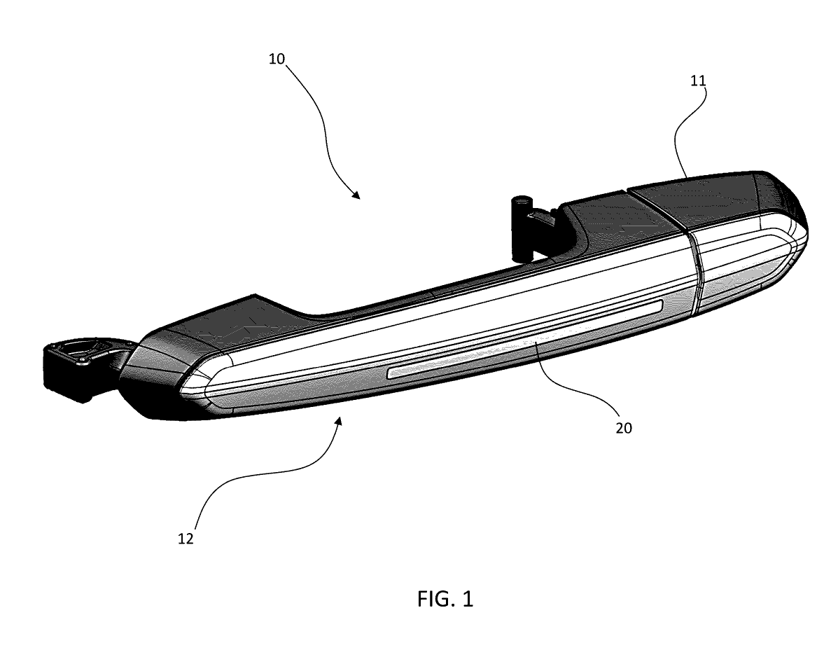

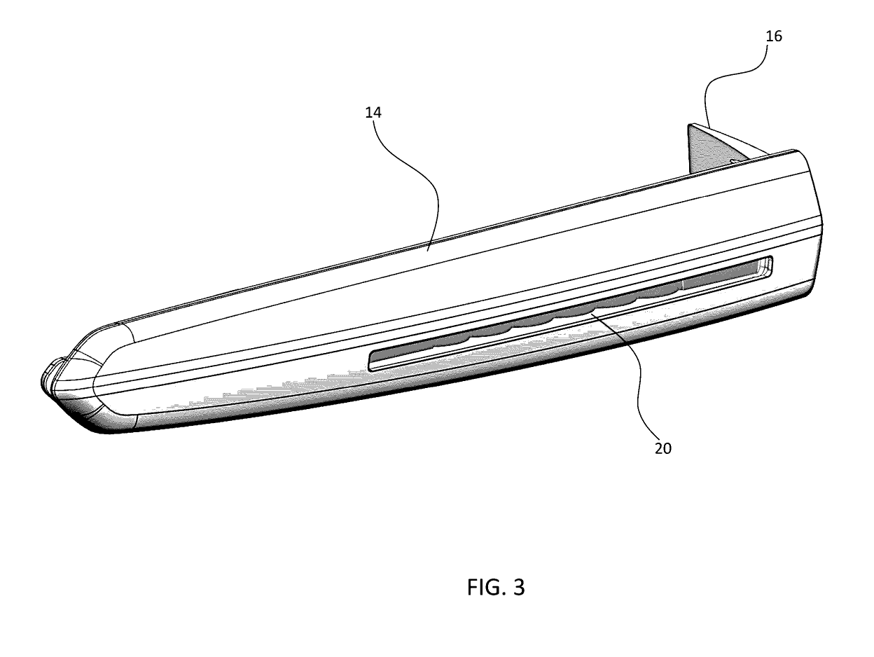

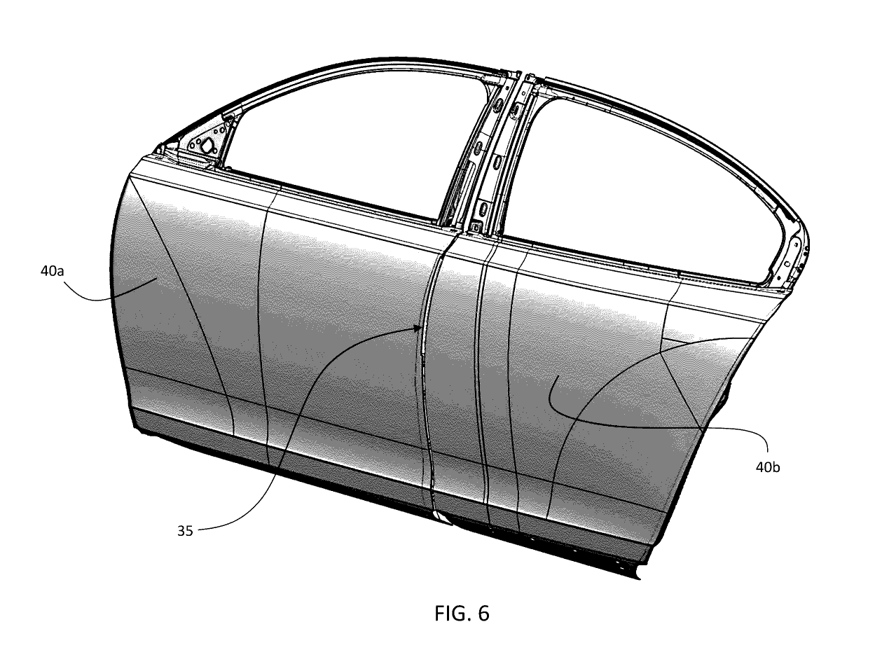

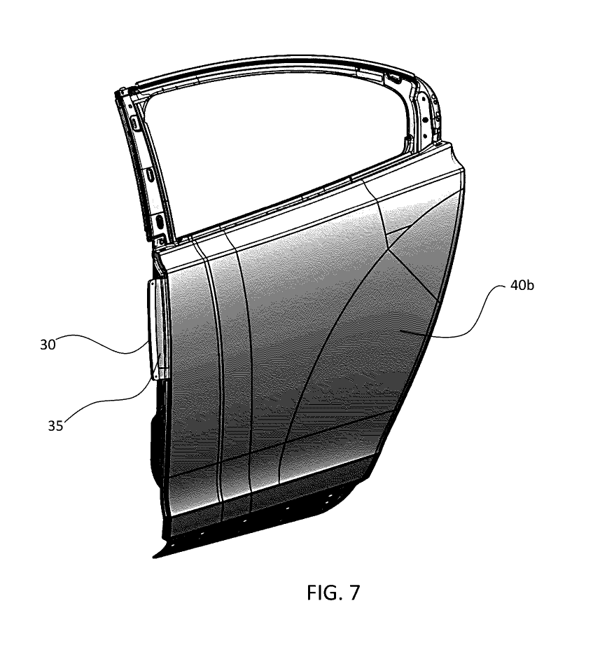

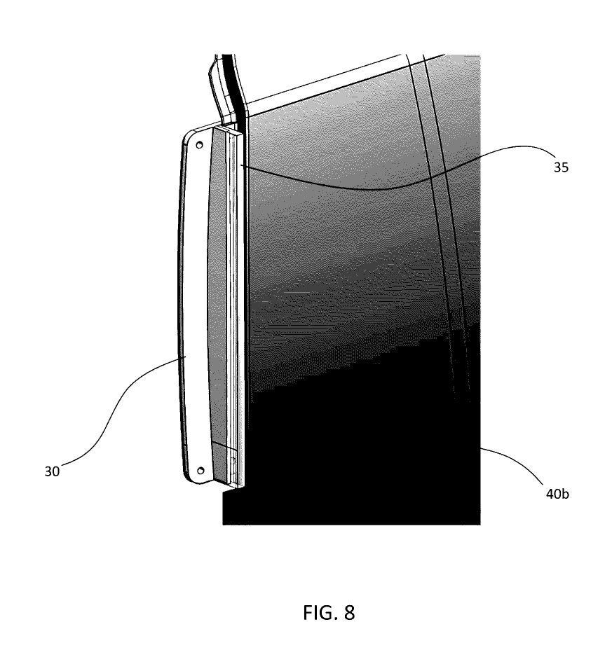

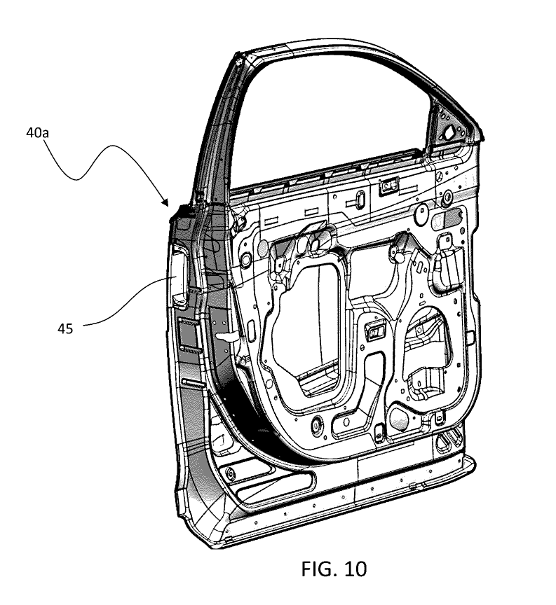

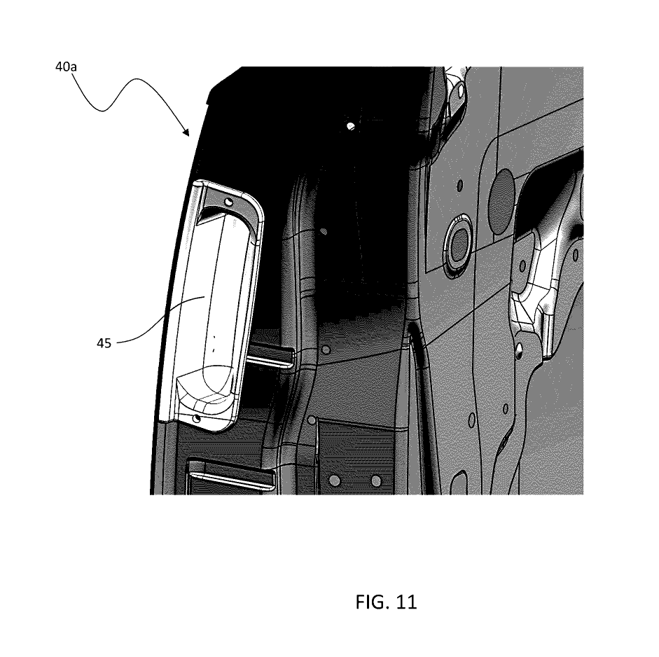

According to the embodiments described herein, the vehicle control apparatus is more particularly adapted as a vehicle door handle (FIGS. 1 through 5) or positioned adjacent to a vehicle door (FIGS. 6 through 11). However, it will be appreciated, with the benefit of this disclosure, that the present invention may be adapted to other forms or locations (e.g., in or adjacent to the B-pillar, proximate a side window, incorporated into any of the belt line trim or rear trim components, tail lamps, appliqués, badges, rear pull cups/handles, or disposed in any other desired location), and that the embodiments particularly described herein are only exemplary.

The “object” whose motion is sensed is, in the exemplary embodiments, the hand of a user. By sensing and distinguishing among a variety of hand motions or gestures, and comparing such sensed motions against pre-defined motions (or, at least, their mathematical equivalents in terms of received signal profiles), the present invention permits users to communicate different intentions by varying the hand motions presented proximate the vehicle control apparatus. Of course, it will be understood that motion of objects other than a user's hand(s) may be sensed in conjunction with the present invention.

As will be appreciated with the benefit of this disclosure, pre-defined vehicle commands (e.g., lock/unlock doors, open doors, turn off/turn on lighting) may be associated with any of a wide variety of object motions, thereby allowing a greater variety of user intentions to be determined and translated into vehicle commands.

Referring now to FIGS. 1 through 5, the present invention according to one embodiment may take the form of a vehicle door access-handle 10 internally incorporating the touchless vehicle control apparatus. More particularly, the embodiment of FIGS. 1 through 5 depicts an exemplary vehicle door access handle as a strap-style handle of the type comprising a base 11 fixed to the vehicle door and a moveable portion 12 adapted to be grasped by a user and pulled outwardly away from the door to release the door latch and, thus, open the door. At least the array of IR LEDs and sensors 50 are packaged within the moveable portion 12. A lens 20 provided in the moveable portion 12 faces outwardly away from the vehicle door (not shown) so as to permit the emission of IR light by the IR LEDs outwardly in the direction of a user approaching or positioned proximate the lens 20.

In the exemplary embodiments the IR LEDS and sensors take the form of a module commercially available from NEONODE, INC. (San Jose, Calif.). The module contains approximately 12 pairs of IR emitters and sensors for receiving reflected IR light. The module has a range of about 200 mm of off-surface detection and the pairs of emitters and sensors permits a higher resolution of detection. For instance, the array of IR LEDs and sensors is capable of detecting the difference between a single finger and multiple fingers. Consequently, the array of IR LEDs and sensors is capable of detecting gesturing. This compares favorably to conventional single LED/sensor modules, which are incapable of such high-resolution detection.

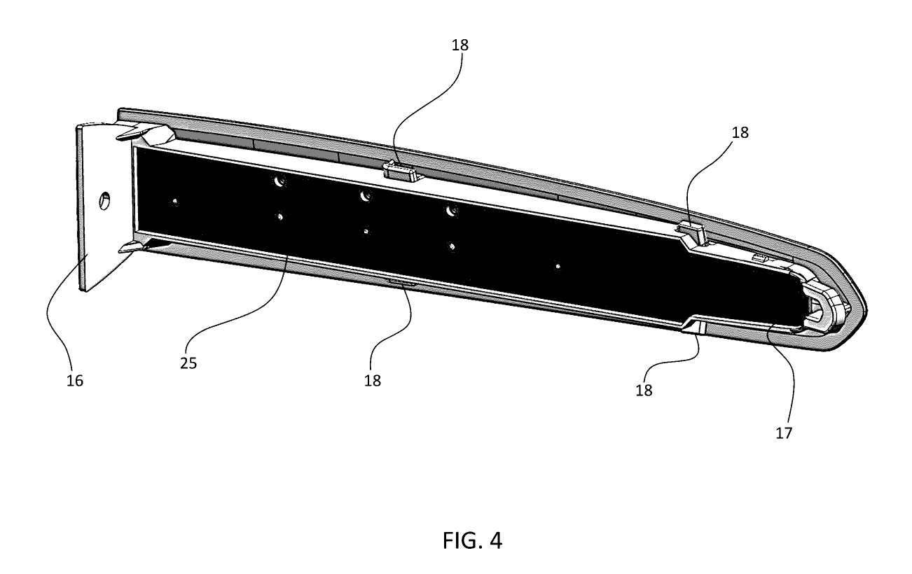

The processing unit (not visible in FIG. 1 or 4) may be positioned completely in the moveable portion 12 of the handle or, alternatively, may be positioned elsewhere on the vehicle and operatively connected to the IR LEDs and sensors. In another form, the processing unit may comprise multiple components, such that a part of the processing unit is positioned in the moveable portion 12 of the handle while the rest of the processing unit is positioned elsewhere on the vehicle and operatively connected to the part in the moveable portion 12. Optionally, the processing unit may be integrated as programming in the vehicle's onboard computer.

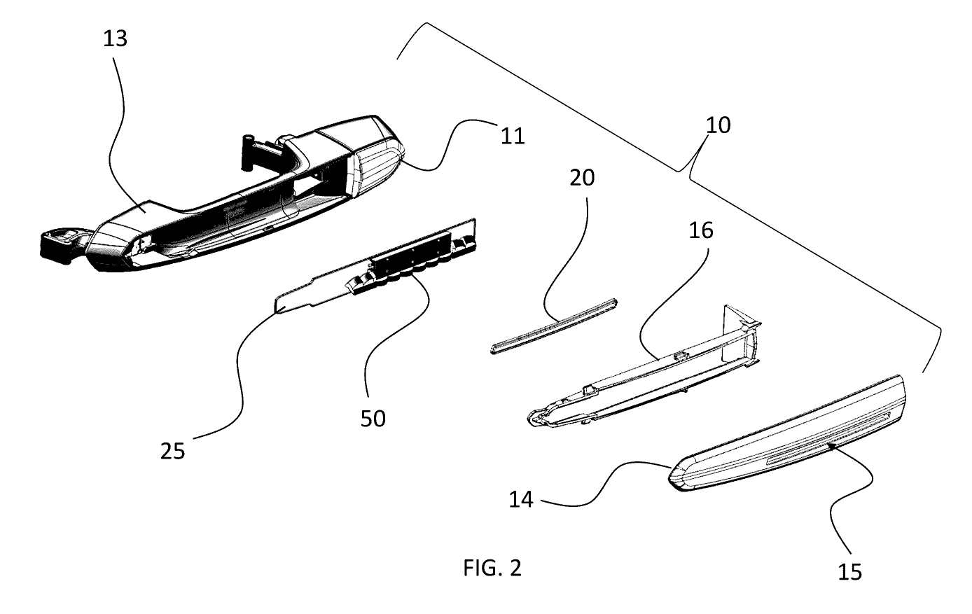

With particular reference to FIG. 2, the access handle 10 is shown in the exemplary embodiment to have a moveable portion 12 comprising an inner, or base, part 13 and an outer, or cover, part 14 which is mated to the base part to define a housing for various components of the control apparatus, as described further herein.

The cover part 14 includes an opening 15 therein in which is mounted the lens 20. The lens 20 may be secured within the opening 15 in any known fashion. In the illustrated embodiment, lens 20 includes a base portion that is wider than the opening 15, whereby the lens is inserted through the opening 15 from the inside of the cover part 14 and the base portion secured to the cover part 14 with epoxy or other suitable adhesive.

Also per the illustrated embodiment, the IR array, the array of IR sensors and the processing unit are all integrated on a single printed circuit board (PCB) 25 which is mounted on a support member 16. Support member 16 is dimensioned to be sandwiched between the base 13 and cover 14 parts so that the PCB 25 is securely positioned within the housing defined by the handle moveable part 12.

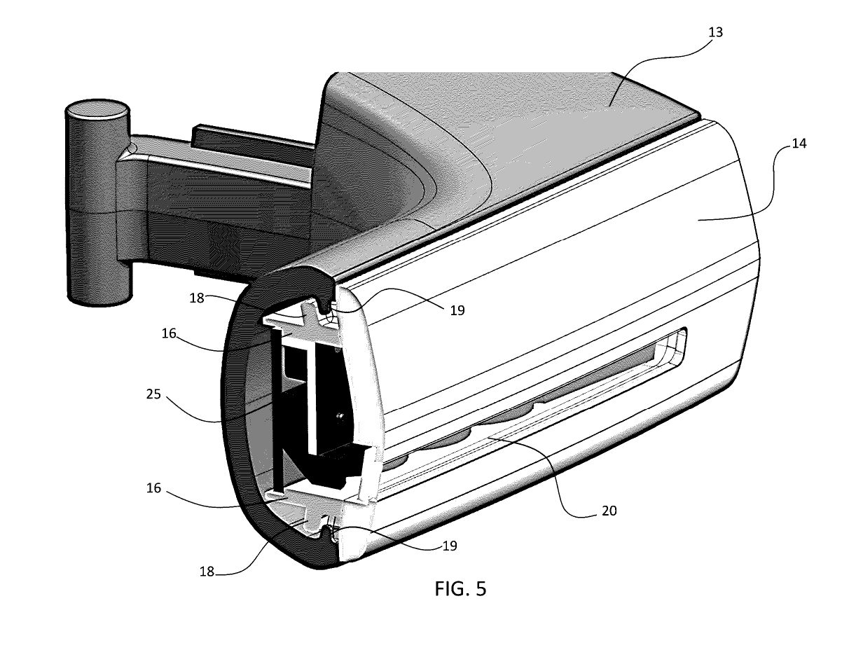

With particular reference to FIGS. 4 and 5, support member 16 can be seen to include a plurality of outwardly facing locking tabs 18 which engage with corresponding locking tabs 19 defined on the base part 13 to securely capture the support member 16 in place within the housing defined by the handle movable part 12. And as shown best in FIG. 4, an opening 17 defined in the support member 16 provides a pass-through for wiring (not depicted) for electrically connecting the PCB 25 to a power source (e.g., the vehicle battery) and, optionally, to one or more of the vehicle's onboard computers in order to effect vehicle commands in the manner hereafter described.

Turning next to FIGS. 6 through 11, there is shown an alternative embodiment of the present invention wherein the vehicle control apparatus is adapted to be secured to a vehicle adjacent to at least one door of the vehicle. More particularly, the illustrated embodiment depicts the vehicle control apparatus as having the IR LED array, the array of IR sensors, and the processing unit integrated on a single PCB which is mounted on a support member 30 secured to the vehicle body in the seam between adjacent doors 40a, 40b. As illustrated, the IR LED and sensor arrays are oriented so as to be able to emit and detect IR light along a length of the generally vertically-oriented seam between the adjacent doors 40a, 40b. In the exemplary embodiment, the IR LED and sensor arrays are positioned proximate the location on the doors 40a, 40b where access handles are typically placed in conventional vehicles. A lens 35 extends the length of the IR LED and sensor arrays to protect the same from the outside environment. Wiring (not depicted) electrically connects the PCB to a power source (e.g., the vehicle battery) and, optionally, to one or more of the vehicle's onboard computers in order to effect vehicle commands in the manner hereafter described.

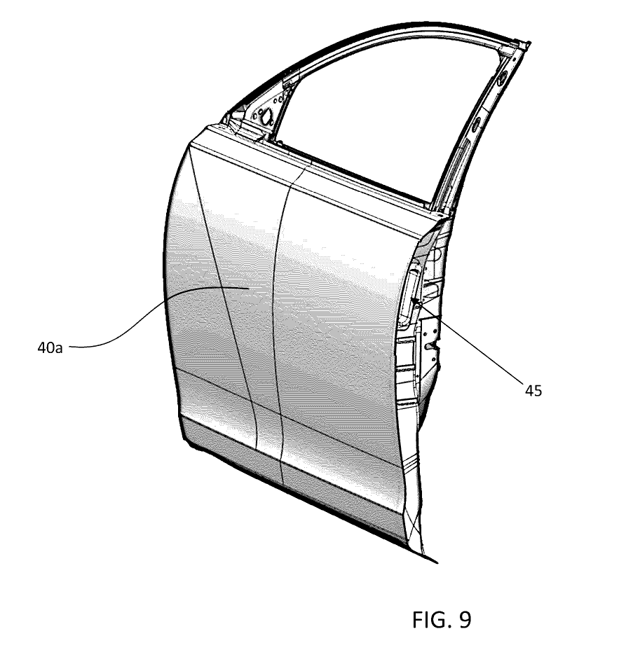

Optionally, the foregoing embodiment of the invention may further comprehend handle-less vehicle doors, as illustrated in FIGS. 6 through 11. In such a system, the vehicle doors are provided with mechanisms operative to at least partially open each vehicle door in response to a determined motion of an object (e.g., a user's hand gesture) corresponding to a pre-defined motion associated with a command to open one or more of the vehicle doors. Along the inside edge of each door is provided a recess or pocket 45, such as illustrated in the door 40a of FIGS. 9 through 11, into which a user may insert his fingers to finish opening the door. Alternatively, it is contemplated that the system of the foregoing embodiment may be provided with mechanisms operative to completely (rather than partially) open each vehicle door.

According to any of the foregoing embodiments, the touchless vehicle control apparatus essentially operates to determine the motion of an object, such as a user's hand gestures, via detection by the IR sensors of reflected IR light from the object in accordance with a time sequence in which one or more of the IR-emitting LEDs is activated and outputting a plurality of reflected signals. The processing unit receives input from the IR sensors corresponding to the detection of the reflected light, identifies a signal function of time by comparing a predetermined threshold with signal levels of the reflected light signals, determines the motion of the object by referring to the signal function of time, and directs the execution of one or more pre-defined vehicle commands when the determined motion of the object corresponds to a pre-defined motion associated with the one or more vehicle commands. Stated more simply, the IR LED's project IR light out through the lens and into an area proximate the exterior of the vehicle. When an object, such as a user's hand, is introduced into the projected IR light, IR light will be bounced back through the same lens into the array of IR sensors. The processing unit interprets the received signals to determine the nature of motion of the object. That is, the processing unit simply “looks” for a predetermined sequence of motions and timing as captured by the IR sensors from the reflected IR light.

Motions/timing detected can be left, right, up, down, in and out with delays at any point. The motion/timing detected can be as simple as any object passing through the zone of the array of IR LEDs and reflecting back IR light to the sensors at any rate or speed. Conversely, the processing unit can look for very specific motions in 2 or 3 dimensions with time based events. For example, and without limitation, the present invention is capable of detecting and distinguishing an object's entering the zone of the array of IR LEDs from the left and moving to the right and past the center of the array, and then back to the center and then the object's holding position for 1.5 seconds before moving out of the zone of the array in a perpendicular direction.

Manifestly, the more complex the preprogrammed gestures which can be detected, the more secure the access system can be. On the other hand, less complicated preprogrammed gestures make it easier to gain access to the vehicle. For instance, the present invention may be adapted to a tailgate door mechanism whereby actuation of the tailgate door is effected upon the detection of a simple preprogrammed gesture such as a user waving a hand or foot in view of the array of IR LEDs and sensors, coupled with authentication of the user via the user-identification challenge system which looks for the presence of an authorized “key-fob remote.” Exemplary IR gesture recognition systems are disclosed in the U.S. Pat. No. 8,643,628, U.S. Pat. No. 8,917,239, U.S. Pat. No. 9,001,087, and U.S. Pat. No. 9,164,625, the disclosure of which are incorporated herein by reference in their entireties. Other exemplary IR gesture recognition systems of the type that may be utilized with the present invention include those disclosed in US Patent Application Publication 20120200486, US Patent Application Publication 20150069249, and US Patent Application Publication 20120312956, the disclosures of which are incorporated herein by reference in their entireties.

In each of the foregoing exemplary embodiments of the present invention, the processing unit is coupled, such as through a wiring harness, to a power source in the vehicle, as well as one or more other controllers or on-board computers, such as the vehicle's body control module, for effecting, in otherwise known fashion, the vehicle commands as determined by the processing unit. Alternatively, or in addition, it will be appreciated that processing unit may be locally programmed with the pre-defined vehicle commands, or some of them, and operative to effect those commands when the determined motion of the object (e.g., the user's hand gestures) corresponds to one or more of the pre-defined motions associated with one or more vehicle commands.

In the door handle embodiment of FIGS. 1 through 5, for instance, the processing unit may, as discussed above, be programmed to detect the movement of a user's hand or other body part towards a handle and, in response, direct the vehicle to activate other access system electronics including authenticating sensors (such as, for instance, the user-identification challenge system which looks for the presence of an authorized “key-fob remote”), lights, etc. Alternatively, such detected movement could result in unlocking and evening partial or full opening of the vehicle door. Still other vehicle commands which can be predefined include, for instance, locking the vehicle's doors, roll down windows (via the window motor units), opening the vehicle's fuel door, turning on exterior and/or interior lighting, etc.

Optionally, it is contemplated that the controller may be programmed by one or more users to learn each pre-defined motion, and to have those learned motions associated with the one or more vehicle commands. So, by way of non-limiting example, it is contemplated that a vehicle user could, by any of various means, enter a “learning” mode of the control apparatus, from which mode the user could create a hand gesture or other object motion that the processing unit would associate with one of the pre-defined vehicle commands. Still more particularly, the user might be instructed to enter, in the foregoing fashion, a motion for the command effecting the unlocking of the vehicle. In response to that instruction, the user would then execute a specific gesture to define the motion to associate with that vehicle command. The processing unit would then memorize the motion as identified via the IR LEDs and sensors and associate it with the vehicle “unlock” command. It will be appreciated that, using smart “key fob” technology, whereby a vehicle may be programmed to recognize different vehicle users through distinct “key fob” codes and associate each such user with particular vehicle settings, that the processing unit may likewise be modified to associate, through the same technology, individual vehicle users with unique motions learned in the manner heretofore described. It is important to note that the construction of the present invention as shown and described in this specification is illustrative only. And although several embodiments of the present invention are described in detail herein, those skilled in the art will appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple elements may be integrally formed, the operation of the interfaces may be reversed or otherwise varied, the length of width of the structures and/or members or connector or other elements of the system may be varied. It is also be noted that the elements and/or assemblies of the exemplary embodiments may be constructed from any of a wide variety of material that provide sufficient strength or durability, in any of a wide variety of colors, textures and combinations. Accordingly, all such modifications are intended to be included within the scope of the present innovations. Other substitutions, modifications, changes and omissions may be made in the design, operating conditions and arrangement of the preferred and other exemplary embodiments without departing from the spirit of the present invention.

The invention in which an exclusive property or privilege is claimed is defined as follows:

1. A touchless vehicle control apparatus, comprising:
an array of infrared light-emitting LEDs;
an array of infrared light sensors for receiving reflected light from an object in accordance with a time sequence in which one or more of the infrared light-emitting LEDs is activated and outputting a plurality of reflected signals; and
a processing unit for receiving the reflected signals, identifying a signal function of time by comparing a predetermined threshold with signal levels of the reflected signals, determining motion of the object by referring to the signal function of time, and directing the execution of one or more pre-defined vehicle commands when the determined motion of the object corresponds to a pre-defined motion associated with a vehicle command.

2. The touchless vehicle control apparatus of claim 1, wherein the apparatus is embodied in a vehicle door release handle.

3. The touchless vehicle control apparatus of claim 1, wherein the apparatus is adapted to be secured to a vehicle adjacent to a door of the vehicle.

4. The touchless vehicle control apparatus of claim 3, wherein the apparatus is adapted to be mounted in a vertically-oriented seam adjacent at least one door in a vehicle, with the array of infrared light-emitting LEDs and the array of infrared light so as to be able to emit and detect IR light along a length of the seam.

5. The touchless vehicle control apparatus of claim 3, wherein the apparatus further comprises a support member adapted to be secured to the vehicle body in the seam adjacent the at least one door.

6. The touchless vehicle control apparatus of claim 4, wherein the apparatus is adapted to be secured to the vehicle body in the seam between adjacent doors.

7. An access system for a vehicle of the type comprising one or more doors providing access to the vehicle interior, comprising:
a recess or pocket provided along the inside edge of each of the one or more doors, the recess or pocket dimensioned to receive the fingers of a user in order to facilitate opening the door;
a mechanism for at least partially opening each of the one or more doors to a position at which a user can access the recess or pocket in the door; and
a touchless control apparatus including an array of infrared light-emitting LEDs, an array of infrared light sensors for receiving reflected light from an object in accordance with a time sequence in which one or more of the infrared light-emitting LEDs is activated and outputting a plurality of reflected signals, and a processing unit for receiving the reflected signals, identifying a signal function of time by comparing a predetermined threshold with signal levels of the reflected signals, determining motion of the object by referring to the signal function of time, and directing the execution of one or more pre-defined vehicle commands when the determined motion of the object corresponds to a pre-defined motion associated with a vehicle command;
wherein the one or more pre-defined vehicle commands includes actuation of the mechanism for at least partially each of the one or more doors so as to partially open at least one of the doors in response to a pre-defined motion of the object.

8. The access system of claim 7, wherein the touchless control apparatus is adapted to be secured to the vehicle adjacent to at least one of the one or more doors.

9. The access system of claim 8, wherein the touchless control apparatus is adapted to be mounted in a vertically-oriented seam adjacent at least one or the one or more doors, with the array of infrared light-emitting LEDs and the array of infrared light so as to be able to emit and detect IR light along a length of the seam.

10. The access system of claim 9, wherein further the touchless control apparatus further comprises a support member adapted to be secured to the vehicle body in the seam adjacent the at least one or more doors.

11. The access system of claim 8, wherein the vehicle includes at least a pair of doors which are positioned adjacent to each other, and wherein further the touchless control apparatus is adapted to be mounted in a vertically-oriented seam between the adjacent doors, with the array of infrared light-emitting LEDs and the array of infrared light so as to be able to emit and detect IR light along a length of the seam.

12. The access system of claim 8, wherein further the touchless control apparatus further comprises a support member adapted to be secured to the vehicle body in the seam between adjacent doors.
